(19) United States
(12) Patent Application Publication
(10) Pub. No.: US 2025/0297563 A1
(43) Pub. Date: Sep. 25, 2025

(54) SILENCER, COOLING SYSTEM, MOTOR SYSTEM AND GENERATOR SYSTEM

(71) Applicant: ABB SCHWEIZ AG, Baden (CH)

(72) Inventors: Qionghao Zhu, Shanghai (CN); Weimin Li, Shanghai (CN); Xiaoliang Zhou, Shanghai (CN)

(21) Appl. No.: 19/230,934

(22) Filed: Jun. 6, 2025

Related U.S. Application Data
(63) Continuation of application No. PCT/CN2023/079845, filed on Mar. 6, 2023.

(51) Int. Cl. F01N 1/24; F01N 13/00

(52) U.S. Cl. CPC F01N 1/24; F01N 13/002; F01N 2260/06; F01N 2470/14

(57) ABSTRACT

A silencer includes a housing and a guiding portion. The housing includes inner walls, provided with a damping material; an inlet, arranged at a first portion of the housing and adapted to receive air from an air outlet of a cooler; a first outlet, arranged at a second portion of the housing and configured to exhaust the air flowing via a first air flow channel, the second portion being adjacent to the first portion; and a second outlet, arranged at a third portion of the housing and configured to exhaust air flowing via a second air flow channel, the third portion being adjacent to the first portion. The guiding portion is arranged at a fourth portion of the housing opposite to the inlet and configured to guide the received air to the first outlet and the second outlet along the first air flow channel and the second air flow channel, respectively.

### FIELD

Embodiments of the present disclosure generally relate to the field of sound absorbing apparatus, and more particularly, to a silencer, a cooling system, a motor system and a generator system.

### BACKGROUND

The control of noise emission is often important in the design and implementation of electronic or mechanical equipment, such as air cooler or air-air cooler. A know structure of silencer for such cooler used in motors and generators has a simple structure, but the ability of absorbing noise cannot fulfill high requirement of sound pressure level from customer, such as 85 or 80 db (A).

Therefore, there is a need for a new approach for improving the ability of absorbing noise.

### SUMMARY

In view of the foregoing problems, various example embodiments of the present disclosure provide a silencer to improve the ability of absorbing noise, and a cooling system, a motor system and a generator system including the silencer is also provided.

In a first aspect of the present disclosure, example embodiments of the present disclosure provide a silencer. The silencer comprises: a housing and a guiding portion. The housing comprises: inner walls, provided with a damping material; an inlet, arranged at a first portion of the housing and adapted to receive air from an air outlet of a cooler; a first outlet, arranged at a second portion of the housing and configured to exhaust the air flowing via a first air flow channel, the second portion being adjacent to the first portion; and a second outlet, arranged at a third portion of the housing and configured to exhaust air flowing via a second air flow channel, the third portion being adjacent to the first portion; and a guiding portion, arranged at a fourth portion of the housing opposite to the inlet and configured to guide the received air to the first outlet and the second outlet along the first air flow channel and the second air flow channel, respectively.

With such an arrangement, the air entering the silencer is guided to outlets through two separated air flow channels. In this way, more noise is absorbed within the housing and lower sound level is achieved.

In some embodiments, the second portion is opposite to the third portion.

With such an arrangement, the air entering the silencer is exhausted through two separated paths. Compared with known solution, noise is not concentrated at one outlet. In this way, more noise is absorbed and lower sound level is achieved.

In some embodiments, the guiding portion extends from the fourth portion of the housing towards the inlet in a way of size reduction.

With such an arrangement, the gradient surface shape of the guiding portion will facilitate to guide the air to flow to the first outlet and the second outlet. In this way, potential noise generated by vortex airflow in the housing will be reduced or eliminated.

In some embodiments, the guiding portion includes a first curved surface and a second curved surface opposite to the first curved surface, to guide the air to flow towards the first outlet and the second outlet, respectively.

With such an arrangement, the first curved surface and a second curved surface facilitate to reduce the resistance of the air flowing in the first air flowing channel and the second air flowing channel, thus reducing the noise generated on the surface of the guiding portion.

In some embodiments, a cross section of the guiding portion has a shape of any of: Y-shaped, triangular, semicircular, and elliptical.

With such an arrangement, the surface of the guiding portion will facilitate to reduce the resistance of the air flowing in the first air flowing channel and the second air flowing channel, thus reducing the noise generated on the surface of the guiding portion.

In some embodiments, the first curved surface and the second curved surface are provided with a damping material.

With such an arrangement, more noise will be absorbed by the damping material.

In some embodiments, the silencer further comprising: a first fence, provided at the first outlet and including at least one first rod extending from a first edge of the first outlet to a second edge of the first outlet opposite to the first edge; and a second fence, provided at the second outlet and including at least one second rod extending from a first edge of the second outlet to a second edge of the second outlet opposite to the first edge of the second outlet; wherein surfaces of the first fence and the second fence in the housing are provided with a damping material.

With such an arrangement, the first fence and the second fence will reflect sound back into the inner walls of the housing, such that the reflected sound is further absorbed by the damping material, thus further reducing the noise.

In some embodiments, inner walls of the guiding portion at the junctions between the guiding portion and the inner wall of the housing comprise round corners, respectively. With such an arrangement, the air flowing to the junctions will be guided smoothly, avoiding or reducing the generation of noise herein. Specifically, round corner of wind path brings lower loss of air flow, less noise generation of corner, and finally achieves better performance of sound level and temperature rise. Better performance of temperature rise can leads to the use of less material of core parts, resulting in cost savings.

In some embodiments, the total area of the first outlet and the second outlet is greater than the area of the air outlet of the cooler.

With such an arrangement, the air from the air outlet of the cooler will be able to flow through the first outlet and the second outlet smoothly, such that the heat generated in the cooler will be dissipated quickly.

In some embodiments, the total area is in the range of 1.2 to 1.5 times the area of the air outlet of the cooler.

With such an arrangement, the heat generated in the cooler will be dissipated quickly through the outlets of the silencer and the housing does not need to be set to have too large volume.

In some embodiments, the housing is positioned so that the first outlet and the second outlet are in the horizontal direction under a working condition.

With such an arrangement, the air from the air outlet of the cooler will be exhausted from two sides of the housing, thus avoiding hot air concentration, whereby facilitating heat balance of the cooler.

In some embodiments, the surfaces of the damping material are provided with a protective film. The surface of protective film is usually smooth and has much less resistance to air.

With such an arrangement, the damping material will be fixed and protected by the protective film. Moreover, the smooth surface makes the air flow more smoothly and the noise here will be less.

In a second aspect, example embodiments of the present disclosure provide a cooling system. The cooling system comprises: an air cooler or an air-air cooler; and a silencer according to any silencer of the first aspect, coupled with the air cooler or an air-air cooler.

With such an arrangement, more noise is absorbed in the silencer and lower sound level is achieved, and thus a cooling system with improved ability of absorbing noise is obtained.

In a third aspect, example embodiments of the present disclosure provide a generator system, comprising: a generator; an air cooler or an air-air cooler, coupled with the generator and configured to cool the generator; and a silencer according to any silencer of the first aspect, coupled with the air cooler or the air-air cooler.

With such an arrangement, more noise is absorbed in the silencer and lower sound level is achieved, and thus a generator system with improved ability of absorbing noise is obtained.

In a fourth aspect, example embodiments of the present disclosure provide a motor system comprising: a motor; an air cooler or an air-air cooler, coupled with the motor and configured to cool the motor; and a silencer according to any silencer of the first aspect, coupled with the air cooler or the air-air cooler.

With such an arrangement, more noise is absorbed in the silencer and lower sound level is achieved, and thus a motor system with improved ability of absorbing noise is obtained.

It is to be understood that the Summary section is not intended to identify key or essential features of embodiments of the present disclosure, nor is it intended to be used to limit the scope of the present disclosure. Other features of the present disclosure will become easily comprehensible through the following description.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is a perspective view illustrating a conventional silencer together with an air-air cooler;

FIG. 2 is a sectional view of the silencer as shown in FIG. 1;

FIG. 3 is a perspective view of a generator system in accordance with an embodiment of the present disclosure;

FIG. 4 is a front view of the generator system as shown in FIG. 3.

FIG. 5 is a left view of the generator system as shown in FIG. 3.

FIG. 6 is a perspective view of a cooling system as shown in FIG. 3; and

FIG. 7 is a sectional view of the cooling system as shown in FIG. 6.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

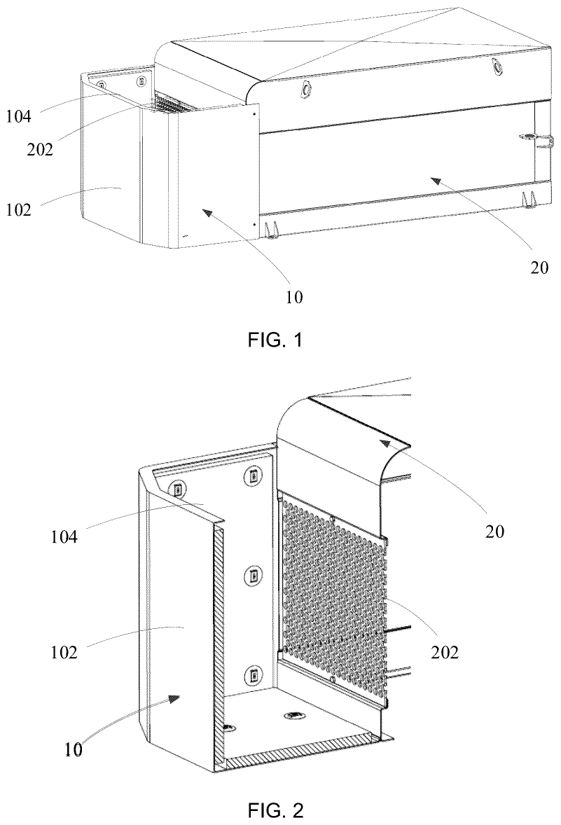

As mentioned above, in some situations, the ability of absorbing noise of the known silencer for an air cooler or an air-air cooler cannot fulfill the high requirement of sound pressure level from customer. For easy understanding of the present invention, a known silencer will be described with reference to FIG. 1 and FIG. 2. FIG. 1 is a perspective view illustrating a conventional silencer together with an air-air cooler; and FIG. 2 is a sectional view of the silencer as shown in FIG. 1.

As shown in FIG. 1, a silencer 10 is coupled to a cooler 20. The cooler 20 may be an air cooler or an air-air cooler. As known, the air cooler has open circulation and the cooling medium is air; while the air-air cooler has two stages of circulation (a primary closed circulation, wherein cooling medium is air; and a secondary open circulation, wherein the cooling medium is also air).

The cooler 20 may be equipped on a motor or a generator to cool the motor or generator. As shown in FIGS. 1 and 2, the air enters the cooler 20 from right side of the cooler 20 to cool the motor or generator. The air after heated becomes hot air, which is output from an air outlet 202 of the cooler 20. The silencer 10 aims to reduce the noise generated by the cooler 20. The silencer 10 includes a housing 102. An outlet 104 is provided on the top of the housing 102. In other words, the outlet 104 faces upward.

As can be seen from FIG. 2, the housing 102 is coupled with the air outlet 202 of the cooler 20. Hot air exhausted from the outlet 202 will enter the housing 10 and exit from the outlet 104 of the silencer 10. The inner walls of the housing 10 will absorb sound wave when the hot air flowing in the housing 10. With this configuration, hot air will be exhausted via only one outlet, i.e., the outlet 104. The noise is concentrated from one air outlet, and thus the resulting noise level is higher. Therefore, there is a need for a new approach for improving the ability of absorbing noise.

The inventor realizes that, in general, the structure of air outlet of a silencer is one of the key influence factors to sound level. It is possible to improve the ability of absorbing noise by changing the design of air outlet of the silencer.

According to embodiments of the present disclosure, a silencer is provided so as to reduce the noise generated by an air cooler or an air-air cooler. The silencer comprises a housing and a guiding portion. The housing comprises: inner walls; an inlet; a first outlet and a second outlet. The inner walls are provided with a damping material, wherein the damping material can absorb sound wave. The inlet is arranged at a first portion of the housing, for example, at a side of the housing. The inlet can receive air from an air outlet of a cooler. The first outlet is arranged at a second portion of the housing which is adjacent to the first portion. The first outlet can exhaust the air flowing via a first air flow channel. The second outlet is arranged at a third portion of the housing which is adjacent to the first portion. The second outlet can exhaust air flowing via a second air flow channel. The guiding portion is arranged at a fourth portion of the housing opposite to the inlet. The guiding portion can guide the received air to the first outlet and the second outlet along the first air flow channel and the second air flow channel, respectively. With such an arrangement, the air entering the silencer is guided to outlets through two separated air flow channels. In this way, more noise is absorbed within the housing and lower sound level is achieved.

The above idea may be implemented in various manners, as will be described in detail in the following paragraphs.

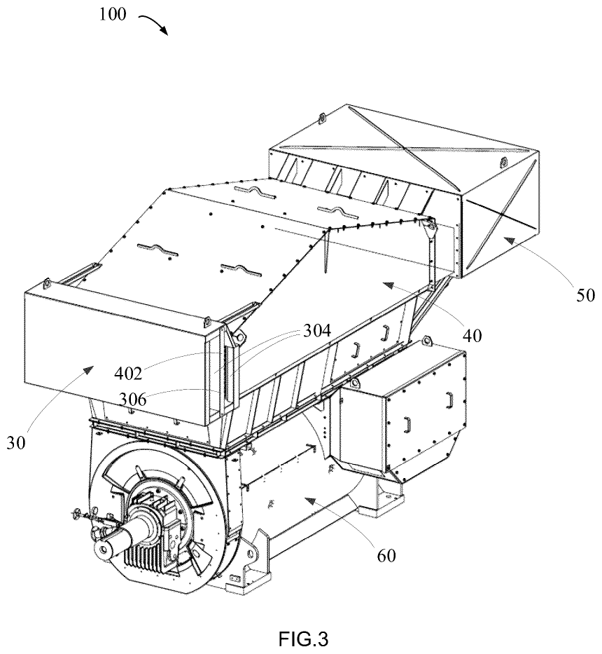

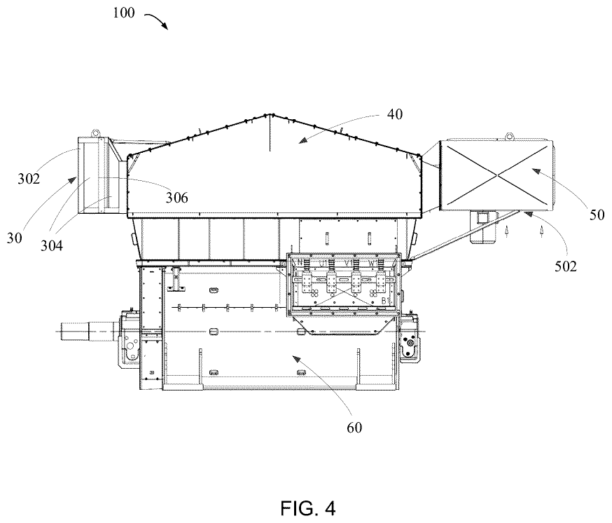

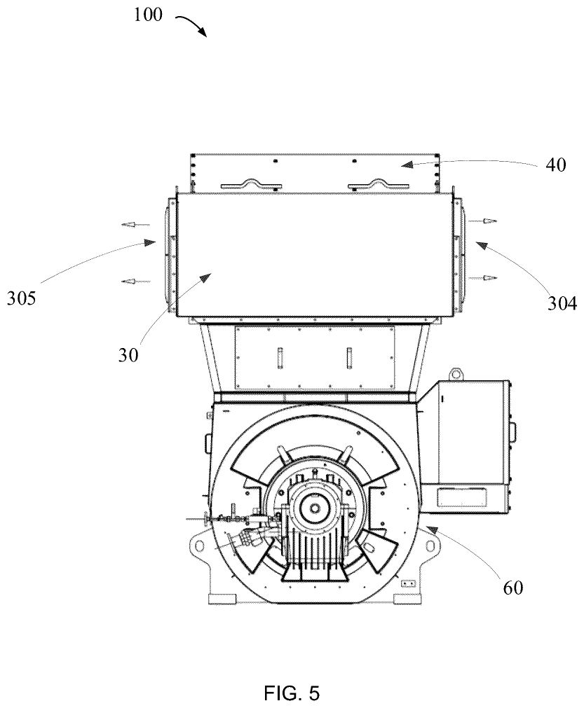

Hereinafter, the principles of the present disclosure will be described in detail with reference to FIGS. 3-5. FIG. 3 is a perspective view of a generator system 100 in accordance with an embodiment of the present disclosure; FIG. 4 is a front view of the generator system 100 as shown in FIG. 3; and FIG. 5 is a left view of the generator system 100 as shown in FIG. 3.

In some embodiments, as shown in FIG. 3, the generator system 100 includes a generator 60 and a cooling system. The cooling system is provided on the top of a generator 60. The cooling system includes a cooler 40, an air input device 50 coupled to a first side of the cooler 40 and a silencer 30 coupled to a second side of the cooler 40. The cooler 40 may be an air cooler or an air-air cooler.

In some embodiments, a plurality of pipes is provided in the cooler 40. Air is input from the air input device 50 into the cooler 40. Specifically, the air entering the cooler 40 are input into the pipes and flows through the pipes. The heat generated by the generator 60 will heat the air around thereof. The heated air will exchange heat with the pipes and the air within the pipes. The air flowing in the pipes will cool the pipes and thus will be heated. Hot air will be exhausted through an air outlet described in detail later. After that, the hot air will enter the silencer 30.

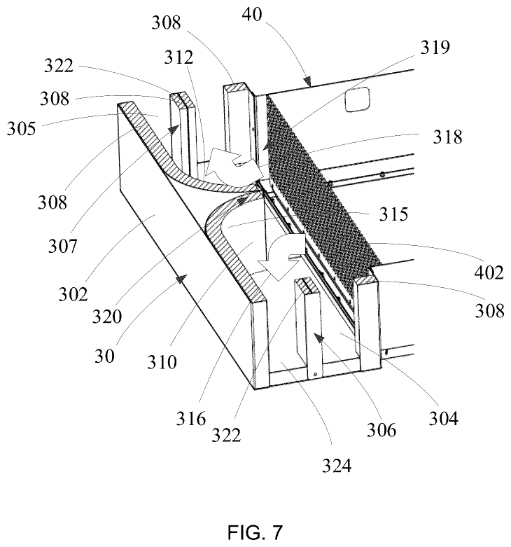

With reference to FIG. 3-5, the silencer 30 comprises a housing 302. The housing 302 comprises: inner walls, an inlet 319 (see FIG. 7), a first outlet 304, and a second outlet 305. The inlet 319 is arranged at a first portion of the housing 302 and configured to receive the air from an air outlet 402 of the cooler 40. The first outlet 304, arranged at a second portion of the housing 302 and configured to exhaust a part of the air entering the housing 302, the second portion being adjacent to the first portion. The second outlet 305 is arranged at a third portion of the housing 302 and configured to exhaust another part of the air entering the housing 302, the third portion being adjacent to the first portion.

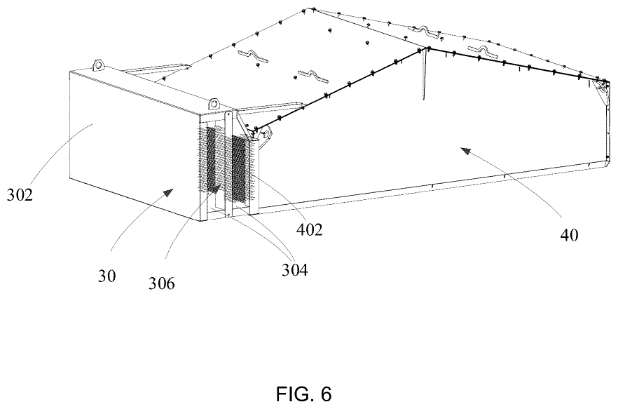

The silencer 30 will be further described in detail hereinafter with reference to FIG. 6-7. FIG. 6 is a perspective view of a cooling system as shown in FIG. 3; and FIG. 7 is a sectional view of the cooling system as shown in FIG. 6.

As shown in FIG. 6 and FIG. 7, the silencer 30 is coupled to the cooler 40. Specifically, the inlet 319 of the silencer 30 is connected with the outlet 402 of the cooler 40. The housing 302 of the silencer 30 may be formed by metal material, such as iron, aluminum, and so on. The scope of the present disclosure is not intended to be limited in this respect.

As shown in FIG. 6 and FIG. 7, inner walls are provided with a damping material 308, which are good at absorbing sound waves. The damping material 308 may be porous sound-absorbing material, for example, muffling cotton.

In some embodiments, as shown in FIG. 6 and FIG. 7, the first outlet 304 is arranged at a second portion of the housing 302, and the second portion is adjacent to the first portion. The second outlet 305 is arranged at a third portion of the housing 302, and the third portion is adjacent to the first portion. As far as the silencer 30 shown in FIG. 6 and FIG. 7 is concerned, the inlet 319 is arranged at a first side of the housing 302, the first outlet 304 is arranged at a second side of the housing 302 which is adjacent to the first side, and the second outlet 305 is arranged at a third side of the housing 302 which is adjacent to the first side.

It is to be understood that the housing 302 is not limited to the shape as described above, but may be of any other shape according to actual requirement and working space thereof. The scope of the present disclosure is not intended to be limited in this respect.

In some embodiments, as shown in FIG. 6 and FIG. 7, the housing 302 further includes a guiding portion 320. The guiding portion 320 is arranged at a fourth portion of the housing 302 opposite to the inlet 319. The guiding portion 320 may be configured to separate the space enclosed by the housing 302, such that a first air flow channel 316 and a second air flow channel 318 are formed in the space. The guiding portion 320 may guide the received air to the first outlet 304 and the second outlet 305 along the first air flow channel 316 and a second air flow channel 318, respectively. The first outlet 304 is configured to exhaust the air flowing via the first air flow channel 316. The second outlet 305 is configured to exhaust air flowing via the second air flow channel 318.

In some embodiments, the guiding portion 320 extends from the fourth portion of the housing 302 towards the inlet 309 in a way of size reduction. In other words, the size of the guiding portion 320 gradually decreases from the fourth portion of the housing 302 to the inlet 309. As shown in FIG. 7, the guiding portion 320 extends from a side of the housing 302 toward the inlet 319. The end of the guiding portion 320 may extend to a position with a predetermined distance from the inlet 319. The predetermined distance may range from, for example, one-tenth to one-half of the distance from the side of the housing 30 to the inlet 319. The scope of the present disclosure is not intended to be limited in this respect. Other predetermined distance is possible depending on the actual requirement.

Theoretically, the plurality of pipes in the cooler 40 is evenly distributed. Actually, the wind speed from each pipe is different, especially in the middle area opposite to the inlet 319. As to the silencer as shown in FIG. 1 and FIG. 2, a disturbance easily occurs in the middle area and thus there will be wind noise friction. In other words, the air hit on the middle area opposite to the inlet 319 will form a vortex, and thus noise will be generated herein. In contrast to the silencer 10 as shown in FIG. 1 and FIG. 2, in the present invention, since the guiding portion 320 is arranged on the middle area opposite to the inlet 319, and the size, in particular, a cross section (as shown in FIG. 7) of the guiding portion 320 gradually decreases toward the inlet 319, air entering the housing 302 will be smoothly guided to the first outlet 304 and the second outlet 305. In this situation, there is little vortex generated. In this way, potential noise generated by vortex airflow in the housing 302 will be reduced.

In some embodiments, the guiding portion 320 includes a first curved surface 310 and a second curved surface 312 opposite to the first curved surface 310, to guide the air to flow towards the first outlet 304 and the second outlet 305, respectively. In particular, the first curved surface 310 defines a portion of the first air flow channel 316, and the second curved surface 312 defines a portion of the second air flow channel 318. With such an arrangement, the first curved surface 310 and the second curved surface 312 facilitate the reduction of the resistance of the air flowing in the first air flowing channel 316 and the second air flowing channel 318, thus reducing the noise generated on the surface of the guiding portion 320.

As shown in FIG. 6 and FIG. 7, the shape of the cross section of the guiding portion 320 is similar to a Y-shape. Actually, the shape as shown is only illustrative. The scope of the present disclosure is not intended to be limited in this respect. In some embodiments, the cross section of the guiding portion 320 has a shape of any of: Y-shaped, triangular, semicircular, elliptical. In this way, the surface of the guiding portion 320 will facilitate the reduction of the resistance of the air flowing in the first air flowing channel 316 and the second air flowing channel 318, thus reducing the noise generated on the surface of the guiding portion 320 in a simple structure.

In some embodiments, the first curved surface 310 and the second curved surface 312 are provided with a damping material 308. As an example, the thickness of the damping material 308 may range from 20 to 100 mm, preferable 50 to 60 mm. It is to be understood that the scope of the present disclosure is not intended to be limited in this respect. With such an arrangement, more noise will be absorbed by the damping material 308.

In some embodiments, inner walls of the guiding portion at the junctions between the guiding portion 320 and the inner wall of the housing 302 comprise round corners 315, respectively. With such an arrangement, the air flowing to the junctions will be guided smoothly, avoiding or reducing the generation of additional noise herein.

As mentioned above, the first outlet is arranged at a second portion of the housing. The second outlet is arranged at a third portion. In some embodiments, the second portion is opposite to the third portion. In this way, the air entering the silencer 30 is exhausted through two separated paths, compared with old solution, two air outlets, i.e., the first outlet 304 and the second outlet 305 can disperse the noise to two sides, which is more conducive to the energy absorption of the damping material 308. In addition, air outlets at both sides are better for balancing the ambient temperature of machine, such as the generator 60, and it is helpful to reduce the air inlet temperature of the machine in a closed space environment. In general, the silencer 30 and the cooler 40 are equipped within an enclosed working space. In this situation, the hot air exited from the housing 302 will flow along two paths, thus the hot air will easily flow evenly in the enclosed space. In this way, more noise is absorbed and lower sound level is achieved.

In some embodiments, the silencer 30 may further comprise: a first fence 306, provided at the first outlet 304 and including at least one first rod extending from a first edge of the first outlet 304 to a second edge of the first outlet 304 opposite to the first edge; and a second fence 307, provided at the second outlet 305 and including at least one second rod extending from a first edge of the second outlet 305 to a second edge of the second outlet 305 opposite to the first edge of the second outlet 305. The surfaces of the first fence 306 and the second fence 307 in the housing 302 are provided with a damping material 308. With such an arrangement, the first fence 306 and the second fence 307 can increase the reflection of sound waves and thus absorb more noise. Specifically, the first fence 306 and the second fence 307 can reflect sound wave back into the housing 302, such that the reflected sound wave is further absorbed by the damping material 308 of the inner walls of the housing 302, thus further reducing the noise.

As shown in FIG. 7, each of the first fence 306 and the second fence 397 includes a supporting part 322, both sides of which are damping material 308. The supporting part 322 may be made of the same material as that of the housing 302. The scope of the present disclosure is not intended to be limited in this respect.

As shown in FIG. 6 and FIG. 7, only one first rod and one second rod are illustrated. It is to be understood that, in other embodiments, the number of the first rod and one second rod may be more than two depending on the actual requirement.

In some embodiments, wind speed at some points near the first outlet 304 or the second outlet 305 can be measured. Experimental results show that the wind speeds at these points are basically the same. This shows that the size design of the structure is reasonable.

As shown in FIG. 6 and FIG. 7, the first outlet 304 and the second outlet 305 are divided into two parts, respectively. One part is of the shape of rectangular, and the other part is of the shape of trapezoid. The present disclosure is not limited in this regard.

In some embodiments, the total area of the first outlet 304 and the second outlet 305 is greater than the area of the air outlet 402 of the cooler 40. In some embodiments, the total area is in the range of 1.2 to 1.5 times the area of the air outlet 402 of the cooler. With such an arrangement, the air from the air outlet 402 of the cooler 40 will be able to flow through the first outlet 304 and the second outlet 305 smoothly, such that the heat generated in the cooler 40 will be dissipated quickly, and the housing 302 does not need to be set to have too large volume.

In some embodiments, the housing 302 is positioned so that the first outlet 304 and the second outlet 305 are in the horizontal direction under a working condition. With such an arrangement, the air from the air outlet of the cooler will be exhausted from two sides of the housing 302, thus avoiding concentration of the hot air, whereby facilitating heat balance of the cooler 40.

In some embodiments, the surfaces of the damping material 308 are provided with a protective film 324. The protective film 324 may fix and protect the damping material 308. The surface of protective film 324 is usually smooth and has much less resistance to air. The smooth surface makes the air flow more smoothly and the noise here will be less.

In a second aspect, example embodiments of the present disclosure provide a cooling system. The cooling system may comprise: an air cooler or an air-air cooler 40; and a silencer 30 as described in the above example embodiments, coupled with the air cooler or an air-air cooler 40. With such an arrangement, more noise can be absorbed in the silencer 30 and lower sound level can be achieved, and thus a cooling system with improved ability of absorbing noise is obtained.

In the embodiments above, the first outlet 304 and the second outlet 305 are illustrated, the scope of the present disclosure is not intended to be limited in this respect. In some embodiments, the silencer 30 may be provided with more than two outlets depending to the actual requirement.

In some embodiments, the sound pressures at a predetermined number of points around the silencer 30 can be measured. The measured sound pressures are weighted to calculate the sound pressure level.

With the same output of power, compared with known solution, the silencer 30 of the present disclosure can absorb more noise and thus lower sound level can be obtained. Experiment shows that the known design of silencer can decrease sound pressure level by 4˜6 dB (A), while the new one of the present disclosure can bring about 8˜10 dB (A) down. That is, the noise reduction effect of the solutions of the present disclosure is 2-3 dB higher than that of the known solution.

The embodiments described above are only illustrative. The scope of the present disclosure is not intended to be limited in this respect.

Actually, the silencer 30 described above is not limited to be used in air cooler system, but can be used in a wider range of industries. For example, the silencer 30 can be used in any industry that needs to reduce noise.

The silencer 30 according to embodiments of the present invention can improve the ability of absorbing noise in a simple structure.

It is to be understood that the silencer 30 is not limited to the configuration as described above, but may be of any other configuration. The scope of the present disclosure is not intended to be limited in this respect.

Moreover, the silencer or the cooling system of the present disclosure can be combined with one or more additional apparatus to operate as needed. The scope of the present disclosure is not intended to be limited in this respect.

As illustrated in FIG. 3 to FIG. 5, example embodiments of the present disclosure provide a generator system 100. The generator system 100 comprises: a generator 60; an air cooler or an air-air cooler 40, coupled with the generator 60 and configured to cool the generator 60; and a silencer 30 according to any silencer 30 as described in the above example embodiments, coupled with the air cooler or an air-air cooler 40. With such an arrangement, more noise is absorbed in the silencer and lower sound level is achieved, and thus a generator system 100 with improved ability of absorbing noise is obtained.

In addition, example embodiments of the present disclosure provide a motor system. The motor system comprises: a motor (not shown); an air cooler or an air-air cooler, coupled with the motor and configured to cool the motor; and a silencer 30 according to any silencer 30 as described in the above example embodiments, coupled with the air cooler or an air-air cooler. With such an arrangement, more noise is absorbed in the silencer and lower sound level is achieved, and thus a motor system with improved ability of absorbing noise is obtained.

It is to be understood that, the generator system 100 and motor system are only illustrative. The scope of the present disclosure is not intended to be limited in this respect.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A silencer comprising:
a housing comprising:
inner walls, provided with a damping material;
an inlet, arranged at a first portion of the housing and adapted to receive air from an air outlet of a cooler;
a first outlet, arranged at a second portion of the housing and configured to exhaust the air flowing via a first air flow channel, the second portion being adjacent to the first portion; and
a second outlet, arranged at a third portion of the housing and configured to exhaust air flowing via a second air flow channel, the third portion being adjacent to the first portion; and
a guiding portion, arranged at a fourth portion of the housing opposite to the inlet and configured to guide the received air to the first outlet and the second outlet along the first air flow channel and the second air flow channel, respectively.

2. The silencer according to claim 1, wherein the second portion is opposite to the third portion.

3. The silencer according to claim 1, wherein the guiding portion extends from the fourth portion of the housing towards the inlet in a way of size reduction.

4. The silencer according to claim 1, wherein the guiding portion comprises a first curved surface and a second curved surface opposite to the first curved surface, to guide the air to flow towards the first outlet and the second outlet, respectively.

5. The silencer according to claim 4, wherein a cross section of the guiding portion has a shape of any of: Y-shaped, triangular, semicircular and elliptical.

6. The silencer according to claim 4, wherein the first curved surface and the second curved surface are provided with a damping material.

7. The silencer according to claim 1, further comprising:
a first fence, provided at the first outlet and comprising at least one first rod extending from a first edge of the first outlet to a second edge of the first outlet opposite to the first edge; and
a second fence, provided at the second outlet and comprising at least one second rod extending from a first edge of the second outlet to a second edge of the second outlet opposite to the first edge of the second outlet;
wherein surfaces of the first fence and the second fence in the housing are provided with a damping material.

8. The silencer according to claim 1, wherein inner walls of the guiding portion at the junctions between the guiding portion and the inner wall of the housing comprise round corners, respectively.

9. The silencer according to claim 1, wherein the total area of the first outlet and the second outlet is greater than the area of the air outlet of the cooler.

10. The silencer according to claim 9, wherein the total area is in the range of 1.2 to 1.5 times the area of the air outlet of the cooler.

11. The silencer according to claim 1, wherein the housing is positioned so that the first outlet and the second outlet are in the horizontal direction under a working condition.

12. The silencer according to claim 1, wherein the surfaces of damping material are provided with a protective film.

13. A cooling system comprising:
an air cooler or an air-air cooler; and
a silencer according to claim 1, coupled with the air cooler or an air-air cooler.

14. A motor system comprising:
a motor;
an air cooler or an air-air cooler, coupled with the motor and configured to cool the motor; and
a silencer according to claim 1, coupled with the air cooler or the air-air cooler.

15. A generator system comprising:
a generator;
an air cooler or an air-air cooler, coupled with the generator and configured to cool the generator; and
a silencer according to claim 1, coupled with the air cooler or the air-air cooler.

16. The silencer according to claim 2, wherein the housing is positioned so that the first outlet and the second outlet are in the horizontal direction under a working condition.

17. The silencer according to claim 3, wherein the housing is positioned so that the first outlet and the second outlet are in the horizontal direction under a working condition.

18. The silencer according to claim 10, wherein the housing is positioned so that the first outlet and the second outlet are in the horizontal direction under a working condition.

19. The silencer according to claim 2, wherein the surfaces of damping material are provided with a protective film.

20. The silencer according to claim 10, wherein the surfaces of damping material are provided with a protective film.
